(19) United States
(12) Patent Application Publication
(10) Pub. No.: US 2008/0185921 A1
(43) Pub. Date: Aug. 7, 2008

(54) Chip-Guiding Structure of a Linear Motor Processing Machine

(76) Inventor: Chi-Tai LIU, Taichung (TW)

Correspondence Address: Dr. BANGER SHIA, 102 Lindencrest Ct., Sugar Land, TX, 77479-5201, US

(21) Appl. No.: 11/672,042

(22) Filed: Feb. 6, 2007

(51) Int. Cl. H02K 5/22; H02K 41/02

(52) U.S. Cl. 310/12; 15/412

(57) ABSTRACT

A chip-guiding structure of a linear motor processing machine comprises an outer cover covers an outer portion of a processing head and can be moved along with a mover and a processing head of the linear motor. A rear end of the outer cover is fixed to the mover to form a closed condition, and a front end of the outer cover is outward expanded to form a spraying mouth. The outer cover is formed with an air inlet for insertion of one end of a guiding pipe of an air compressor, enabling the high pressure gas to transport into the outer cover from the guiding pipe via the air inlet. Thereby, the chips produced during the processing course will be blown out of the spraying mouth, so as to prevent the chips from entering the important components of the motor.

### BACKGROUND OF THE INVENTION

1. Field of the Invention

The present invention relates to a chip-guiding structure of a linear motor processing machine, and more particularly to a chip-guiding structure of a linear motor processing machine, which comprises an outer cover for covering an outer portion of a processing head, so as to prevent the chips from entering the linear motor processing machine.

2. Description of the Prior Art

Referring to FIG. 1, a conventional linear motor processing machine 1 comprises a stator 10 and a mover 11. The mover 11 is located correspondingly to the stator 10, and cooperates with a guideway, a sliding block and a platform to move along the stator 10 transversely. A processing head 12 is disposed on the mover 11 (the kind of the processing head 12 can be chosen according to different processing machines). At present, the linear motor is widely used in the processing machine such as a machine tool, a circuit board driller or a laser processing machine.

The above-mentioned linear motor processing machine has good processing effect, however, when in use, the conventional linear motor processing machine still has some shortcomings need to be improved. For example, the chips produced when processing are unable to be separated or removed appropriately. Since the chips are inevitably produced during the processing course, and the chips will be separated from the work piece and go in different directions, which may has little influence on the non-precision mechanical processing operation. But for the precision linear motor processing machine, if the chips enter the important components (such as a stator of the linear motor), the linear motor processing machine will be damaged, or the processing precision will be influenced. Thereby, it is necessary to prevent the chips from interfering with the linear motor processing machine.

In order to prevent the chips from entering the linear motor processing machine, the equipments or important components (such as the stator of the linear motor) are usually covered by means of bellows wrapping, so as to separate the chips. This method wraps a large area, which doesn't meet the requirements of the cost or appearance. On the other hand, the linear motor is likely to exceed the allowable range of the bellows when rotating at a high speed, as a result, the protection will fail.

The present invention has arisen to mitigate and/or obviate the afore-described disadvantages.

### SUMMARY OF THE INVENTION

The primary objective of the present invention is to provide a chip-guiding structure of a linear motor processing machine comprises an outer cover covers an outer portion of a processing head and can be moved along with the processing head, such that the chips produced during the processing course will be separated from the processing machine by the guiding of the outer cover, so as to prevent the chips from entering the important components of the processing machine.

To achieve the object of the present invention, a chip-guiding structure of a linear motor processing machine comprises an outer cover covers an outer portion of the processing head and moves along with a mover and a processing head of the linear motor, a rear end of the outer cover is fixed to the mover to form a closed condition, and a front end of the outer cover is outward expanded to form a spraying mouth. The outer cover cooperates with the high pressure gas to provide the high pressure air stream blowing from inside to outside, enabling the chips produced during the processing course to be blown out of the spraying mouth by the air stream, so as to prevent the chips from entering the important components of the processing machine.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional linear motor processing machine;

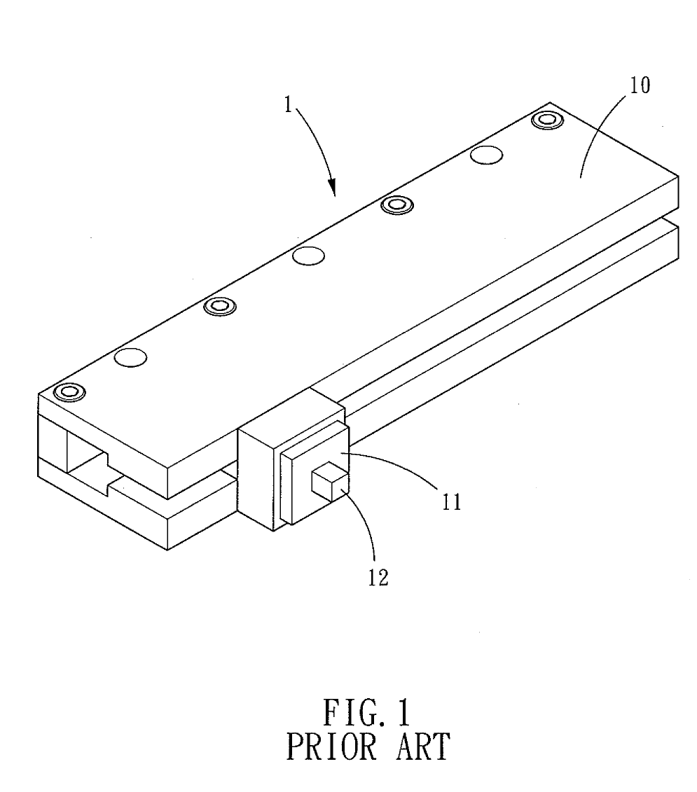

FIG. 2 is a perspective view of a chip-guiding structure of a linear motor processing machine in accordance with the present invention; and

FIG. 3 is a cross sectional view of the chip-guiding structure of a linear motor processing machine in accordance with the present invention.

### DETAILED DESCRIPTION OF THE PREFERRED EMBODIMENTS

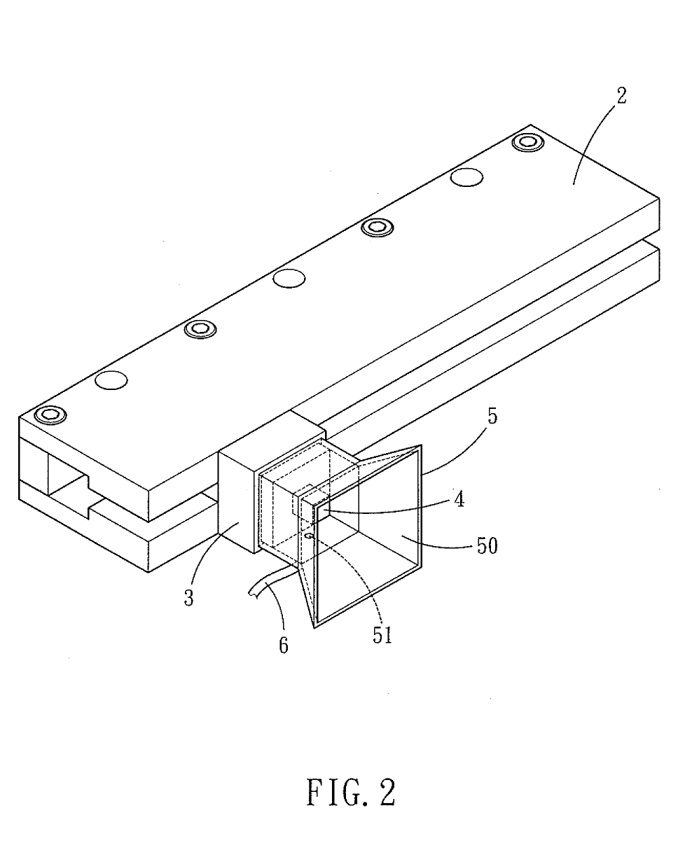

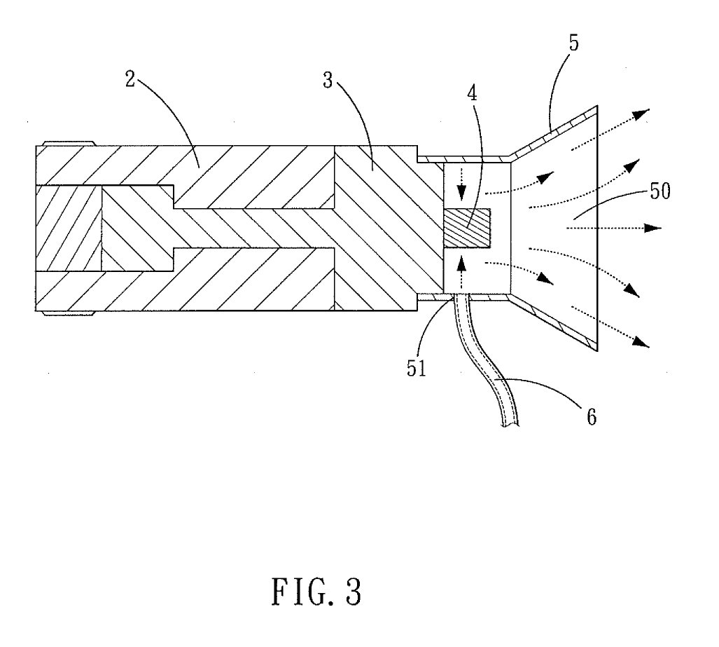

Referring to FIGS. 2 and 3, a chip-guiding structure of a linear motor processing machine in accordance with the present invention comprises a stator 2, a mover 3 and an outer cover 5.

The stator 2 is fixed to a platform of the motor processing machine.

The mover 3 is located correspondingly to the stator 2, and cooperates with a guideway and a sliding block to move along the stator 2. One end of the mover 3 is disposed with a processing head 4, and the kind of the processing head 4 can be chosen according to different processing machines.

The outer cover 5 is a hollow member, a rear end of the outer cover 5 is fixed to the mover 3 to form a closed condition, and a front end of the outer cover 5 is outward expanded to form a spraying mouth 50. An air inlet 51 is defined in a suitable position of the rear end of the outer cover 5 for insertion of one end of a guiding pipe 6, and the other end of the guiding pipe 6 is connected to an air compressor, such that the high pressure gas can be transported into the outer cover 5 from the guiding pipe 6 via the air inlet 51, so as to provide a high pressure air stream blowing from inside to outside.

During operation, the outer cover 5 covers an outer portion of the processing head 4 and moves along with the mover 3 and the processing head 4 of the linear motor. When the linear motor processing machine is processing, the user can start the air compressor, enabling the high pressure gas to transport into the outer cover 5 from the guiding pipe 6 via the air inlet 51, so as to provide the high pressure air stream blowing from inside to outside. Thereby, the chips (such as saw dust, metal cuttings or chips of other material) produced during the processing course will be blown out of the spraying mouth 50 by the air stream, such that the chips will be separated from the linear motor processing machine. Moreover, the air stream blown to the outside from the spraying mouth 50 will form an air barrier, so as to separate the chips from the processing machine, thus preventing the chips from entering the stator 2 of the linear motor and protecting the motor completely.

The outer cover 5 that moves along with the mover 3 of the present invention is provided for covering the outer portion of the processing head 4, such that the processing area will form an air barrier, so as to separate the chips from the processing machine. In addition, the outer cover 5 is simplified in structure and can be moved along with the mover 3 and the processing head 4, thereby, no matter the working of high speed or low speed, the chips will not enter the important components of the linear motor processing machine.

To summarize, the outer cover of the present invention not only simplified in structure, but also can prevent the chips from entering the linear motor processing machine. Thereby, the present invention is practical.

While we have shown and described various embodiments in accordance with the present invention, it should be clear to those skilled in the art that further embodiments may be made without departing from the scope of the present invention.

What is claimed is:

1. A chip-guiding structure of a linear motor processing machine, comprising:
a stator fixed to a platform of the motor processing machine;
a mover located correspondingly to the stator and moves along the stator;
a processing head disposed at one end of the mover; characterized in that:
an outer cover is a hollow member and covers an outer portion of the processing head, a rear end of the outer cover is fixed to form a closed condition, a front end of the outer cover is formed with a spraying mouth; and
at least one air inlet is defined in the outer cover for guiding the air.

2. The chip-guiding structure of a linear motor processing machine as claimed in claim 1, wherein the rear end of the outer cover is fixed to the mover, and the outer cover is moved along with the mover and the processing head.

3. The chip-guiding structure of a linear motor processing machine as claimed in claim 1, wherein the spraying mouth formed at the front end of the outer cover is outward expanded.

4. The chip-guiding structure of a linear motor processing machine as claimed in claim 1, wherein one end of a guiding pipe is inserted into the air inlet of the outer cover, and the other end of the guiding pipe is connected to an air compressor, enabling the high pressure gas to transport into the outer cover from the guiding pipe via the air inlet, so as to provide the high pressure air stream blowing from inside to outside.
